(19) United States
(12) Patent Application Publication
(10) Pub. No.: US 2025/0075977 A1
(43) Pub. Date: Mar. 6, 2025

(54) HEAT TREATMENT FURNACE

(71) Applicants: NGK INSULATORS, LTD., Nagoya-Shi (JP); NGK KILNTECH, CORPORATION, Nagoya-Shi (JP)

(72) Inventors: Kazuya NARUMIYA, Nagoya-Shi (JP); Takeshi KOMAKI, Nagoya-Shi (JP); Minoru YAMAGUCHI, Nagoya-Shi (JP); Terukazu IWATA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/676,638

(22) Filed: May 29, 2024

(30) Foreign Application Priority Data
Sep. 4, 2023 (JP) 2023-143162

(51) Int. Cl. F27B 9/04; F27B 9/02; F27B 9/36

(52) U.S. Cl. CPC F27B 9/045; F27B 9/028; F27B 9/36

(57) ABSTRACT

A heat treatment furnace may include: a furnace body comprising a heat treatment space; a plurality of movable members; a pusher configured to push the plurality of movable members forward; and a plurality of gas supplying pipes each comprising a gas supplying opening, the gas supplying pipes being aligned in a left-right direction. Each of the movable members may be positioned between a corresponding pair of the gas supplying pipes adjacent in the left-right direction. The heat treatment furnace may include a plurality of gas exhausting openings through which the furnace atmosphere gas in the heat treatment space is exhausted to outside of the furnace body. As the furnace body is viewed in the front-rear direction, the gas exhausting openings may be positioned directly above the intervals between stacks of objects aligned in the left-right direction on the movable members.

### REFERENCE TO RELATED APPLICATIONS

This application claims priority to Japanese Patent Application No. 2023-143162, filed on Sep. 4, 2023, the entire contents of which are hereby incorporated by reference into the present application.

### TECHNICAL FIELD

The disclosure herein relates to a heat treatment furnace.

### BACKGROUND ART

Japanese Patent Application Publication No. 2021-162246 describes a heat treatment furnace that heat-treats a plurality of objects. The heat treatment furnace includes a furnace body having an entrance and exit; a movable member configured to be pushed by a pusher in a direction from the entrance toward the exit, wherein stacks of objects stacked in an up-down direction are placed on the movable member; and a plurality of gas supplying pipes each having a gas supplying opening through which furnace atmosphere gas is supplied into a heat treatment space. A plurality of gas exhausting openings is defined in an upper wall of the furnace body.

### SUMMARY

By stacking objects to be heat treated in an up-down direction and aligning these stacks in a left-right direction on a movable member, a large number of objects is placed in a heat treatment furnace. In this case, the objects may affect a flow of furnace atmosphere gas in the furnace body. In a heat treatment furnace such as the one described in Japanese Patent Application Publication No. 2021-162246, the gas exhausting openings are positioned near the left end of the upper wall of the furnace body (i.e., near a left wall extending in a conveying direction) and near the right end of the upper wall (i.e., near a right wall extending in the conveying direction). That is, the gas exhausting openings and the gas supplying openings are not positioned considering the layout of the objects. Therefore, the furnace atmosphere gas tends to stagnate within the heat treatment furnace.

The disclosure herein provides a technology that suppresses furnace atmosphere gas from stagnating within a heat treatment furnace.

In a first aspect of the art disclosed herein, a heat treatment furnace may comprise: a furnace body comprising an entrance, an exit, and a heat treatment space in which a plurality of objects is heat-treated; a plurality of movable members on which stacks of objects stacked in an up-down direction are aligned at intervals in a left-right direction perpendicular to the up-down direction, the plurality of movable members being aligned in a front-rear direction; a pusher configured to push the plurality of movable members forward from the entrance of the furnace body to the exit of the furnace body; and a plurality of gas supplying pipes each comprising a gas supplying opening through which furnace atmosphere gas is supplied into the heat treatment space, the gas supplying pipes being aligned in the left-right direction. Each of the movable members may be positioned between a corresponding pair of the gas supplying pipes adjacent in the left-right direction. The gas supplying openings of the gas supplying pipes may be arranged so as to supply the furnace atmosphere gas to the stacks of objects. The heat treatment furnace may include a plurality of gas exhausting openings through which the furnace atmosphere gas in the heat treatment space is exhausted to outside of the furnace body. As the furnace body is viewed in the front-rear direction, the gas exhausting openings may be positioned directly above the intervals between the stacks of objects aligned in the left-right direction on the movable members.

According to the configuration above, the furnace atmosphere gas supplied from the gas supplying pipes into the heat treatment space flows between the stacks of objects stacked in the up-down direction and into the intervals between the stacks of objects aligned in the left-right direction on the movable members. The furnace atmosphere gas then flows upward in the intervals of the stacks of objects. Since the gas exhausting openings are positioned directly above the intervals between the stacks of objects as the furnace body is viewed in the front-rear direction, the furnace atmosphere gas flows toward the gas exhausting openings after flowing in the intervals between the stacks of objects. If a gas is generated from the objects, the furnace atmosphere gas flows together with this gas toward the gas exhausting openings. Finally, the furnace atmosphere gas is exhausted, together with the gas from the objects, to the outside of the furnace body through the gas exhausting openings. The furnace atmosphere gas is thus suppressed from stagnating within the furnace body.

### BRIEF DESCRIPTION OF DRAWINGS

FIG. 1 schematically shows a cross-sectional view of a heat treatment furnace according to a first embodiment.

FIG. 2 shows a front view of a plurality of objects on movable members according to the first embodiment.

FIG. 3 shows a horizontal cross-sectional view of an object according to the first embodiment.

FIG. 4 schematically shows a cross-sectional view of the heat treatment furnace along a line IV-IV in FIG. 1.

FIG. 5 shows a cross-sectional view illustrating an uppermost object and a first partition wall according to the first embodiment.

FIG. 6 schematically shows a cross-sectional view of the heat treatment furnace along a line VI-VI in FIG. 1.

FIG. 7 shows a partial horizontal cross-sectional view of the heat treatment furnace according to the first embodiment.

FIG. 8 shows a cross-sectional view illustrating a leftmost object (an object closest to a second partition wall) and a second partition wall according to the first embodiment.

FIG. 9 schematically shows a cross-sectional view of movable members, gas supplying pipes positioned around the movable members, and a furnace body in the heat treatment furnace according to the first embodiment.

FIG. 10 shows a block diagram including heaters, a pusher, regulating valves, and a controller according to the first embodiment.

FIG. 11 schematically shows a side view illustrating objects and a gas supplying pipe according to the first embodiment when cutouts of the objects do not overlap the gas supplying pipe as viewed in a left-right direction.

FIG. 12 schematically shows a side view illustrating the objects and the gas supplying pipe according to the first embodiment when the cutouts of the objects overlap the gas supplying pipe as viewed in the left-right direction.

FIG. 13 schematically shows a cross-sectional view of the furnace body, objects placed in a furnace internal space, and a gas supplying pipe in the heat treatment furnace according to the first embodiment.

FIG. 14 shows a partial horizontal cross-sectional view of a heat treatment furnace according to a second embodiment.

FIG. 15 shows a partial horizontal cross-sectional view of the heat treatment furnace according to the second embodiment.

FIG. 16 schematically shows a cross-sectional view of a furnace body, objects placed in a heat treatment space, and heaters in a heat treatment furnace according to a third embodiment.

FIG. 17 schematically shows a cross-sectional view of a furnace body, objects placed in a furnace internal space, and a gas supplying pipe in a heat treatment furnace according to a fourth embodiment.

FIG. 18 schematically shows a cross-sectional view of movable members, gas supplying pipes around the movable members, and the furnace body in the heat treatment furnace according to the fourth embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment furnaces, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the art disclosed herein according to the above-mentioned first aspect, a width of the gas exhausting openings in the left-right direction may be at least the same as a width of the intervals in the left-right direction between the stacks of objects aligned in the left-right direction and at most three times the width of the intervals. This configuration allows the furnace atmosphere gas to be exhausted, together with a gas generated from the objects, to the outside of the furnace body through the gas exhausting openings even when the furnace atmosphere gas spreads rightward and/or leftward as it flows toward an upper wall after flowing in the intervals between the objects (intervals in the left-right direction). Therefore, the furnace atmosphere gas is less likely to stagnate within the furnace body.

In a third aspect of the art disclosed herein according to the above-mentioned first or second aspect, the gas supplying pipes may be aligned in the front-rear direction. A distance between each pair of the gas supplying pipes adjacent in the front-rear direction may be an integral multiple of a length of each movable member in the front-rear direction. Generally, in a heat treatment furnace using a pusher, movable members are moved, when pushed by the pusher once, by a distance corresponding to the length of the movable members in the front-rear direction. The configuration above allows the furnace atmosphere gas to be supplied evenly to the objects on the movable members.

In a fourth aspect of the art disclosed herein according to any one of the above-mentioned first to third aspects, the heat treatment furnace may further comprise: a regulating valve configured to permit the furnace atmosphere gas to be supplied from the gas supplying openings when the regulating valve is open and prohibit the furnace atmosphere gas from being supplied from the gas supplying openings when the regulating valve is closed; and a controller configured to control opening and closing of the regulating valve. Each of the objects may comprise a cutout in an upper portion of the object and the cutout is configured to allow an inside of the object to communicate with an outside of the object. The controller may be configured to open the regulating valve when the gas supplying pipes overlap the cutouts in the left-right direction. According to the configuration above, the furnace atmosphere gas is supplied from the gas supplying openings when the gas supplying pipes overlap the cutouts in the left-right direction. This allows the furnace atmosphere gas to be efficiently supplied into the objects.

In a fifth aspect of the art disclosed herein according to any one of the above-mentioned first to fourth aspects, the heat treatment furnace may further comprise: a plurality of regulating valves, wherein the regulating valves are configured to switch a supplying amount of the furnace atmosphere gas to be supplied from the gas supplying openings between a first supplying amount and a second supplying amount different from the first supplying amount; and a controller configured to control the plurality of regulating valves. With regard to each pair of the gas supplying pipes adjacent in the left-right direction, the gas supplying opening of one of the gas supplying pipes may face the gas supplying opening of the other of the gas supplying pipes. The controller may be configured to switch the supplying amount to be supplied from the gas supplying opening of the other of the gas supplying pipes to the second supplying amount when switching the supplying amount to be supplied from the gas supplying opening of the one of the gas supplying pipes to the first supplying amount. In the configuration above, the furnace atmosphere gas is stirred within the heat treatment space, and thereby the concentrations of components of the gas generated from the objects are evened out in the furnace atmosphere gas within the heat treatment space.

In a sixth aspect of the art disclosed herein according to any one of the above-mentioned first to fifth aspects, the heat treatment space may comprise a plurality of furnace internal spaces aligned in the front-rear direction and defined by a plurality of first partition walls positioned above the objects. At least one gas exhausting opening may be positioned in each of the plurality of furnace internal spaces. This configuration suppresses the furnace atmosphere gas from stagnating within each furnace internal space.

In a seventh aspect of the art disclosed herein according to the above-mentioned sixth aspect, the heat treatment furnace may further comprise: a plurality of guide rails extending in the front-rear direction and configured to guide the movable members forward, wherein each of the movable members is positioned between a corresponding pair of the guide rails adjacent in the left-right direction; and a plurality of second partition walls extending from the guide rails to the first partition walls. This configuration suppresses the furnace atmosphere gas supplied from the gas supplying pipes from flowing from a furnace internal space to an adjacent furnace internal space.

In an eighth aspect of the art disclosed herein according to the above-mentioned seventh aspect, a distance between each second partition wall and the stacks of the objects in the left-right direction may be equal to or more than 10 mm and equal to or less than 30 mm. This configuration suppresses the second partition walls from contacting the stacks of objects, while suppressing the furnace atmosphere gas supplied from the gas supplying pipes from flowing from a furnace internal space to an adjacent furnace internal space.

In a ninth aspect of the art disclosed herein according to any one of the above-mentioned sixth to eighth aspects, in each of the furnace internal spaces, a distance between the at least one gas exhausting opening and the gas supplying pipes in the front-rear direction may be more than a length of the movable members in the front-rear direction. This configuration allows the furnace atmosphere gas to contact the objects for a long time in each furnace internal space.

In a tenth aspect of the art disclosed herein according to any one of the above-mentioned sixth to ninth aspects, a distance between the first partition walls and the stacks of the objects may be equal to or more than 10 mm and equal to or less than 30 mm. This configuration suppresses the objects from contacting the first partition walls, while suppressing the furnace atmosphere gas from flowing through between the first partition walls and the objects.

In an eleventh aspect of the art disclosed herein according to any one of the above-mentioned first to tenth aspects, the heat treatment furnace may further comprise a heating heater and a heat-retention heater positioned in the heat treatment space. The heat treatment space may comprise a plurality of furnace internal spaces aligned in the front-rear direction. The plurality of furnace internal spaces may comprise: a heating space in which the heating heater is positioned and communicating with the entrance; and a heat-retention space in which the heat-retention heater is positioned and communicating with the heating space. The gas exhausting openings may be positioned in the heating space. In the configuration above, the furnace atmosphere gas heated in the heat-retention space and a gas generated from the objects flow into the heating space, thereby the heating space is heated. Therefore, the configuration above allows for a reduction in an amount of heat generation by the heating heater as compared to a configuration in which the furnace atmosphere gas and the gas generated from the objects do not flow from the heat-retention space into the heating space.

In a twelfth aspect of the art disclosed herein according to any one of the above-mentioned first to eleventh aspects, the gas supplying pipes may be constituted of ceramics. In this configuration, the gas supplying pipes are more resistant to heat than gas supplying pipes constituted of different materials from ceramics. Therefore, thermal damage to the gas supplying pipes can be suppressed in the heat treatment furnace used under a high temperature condition. Further, if the gas supplying pipes are constituted of a metal, the objects may be contaminated by the metal, thereby the quality of the objects could be deteriorated. The configuration above suppresses such a quality deterioration of the objects due to metal contamination.

In a thirteenth aspect of the art disclosed herein according to any one of the above-mentioned first to twelfth aspects, the heat treatment furnace may further comprise supplying pipes connected to the gas supplying pipes and configured to supply the furnace atmosphere gas to the gas supplying pipes. The supplying pipes may extend through a wall portion of the furnace body. In the configuration above, the furnace atmosphere gas is heated by the furnace body while flowing through the supplying pipes. Therefore, the configuration above suppresses a temperature drop within the heat treatment space when the furnace atmosphere gas is supplied to the heat treatment space from the supplying pipes.

### FIRST EMBODIMENT

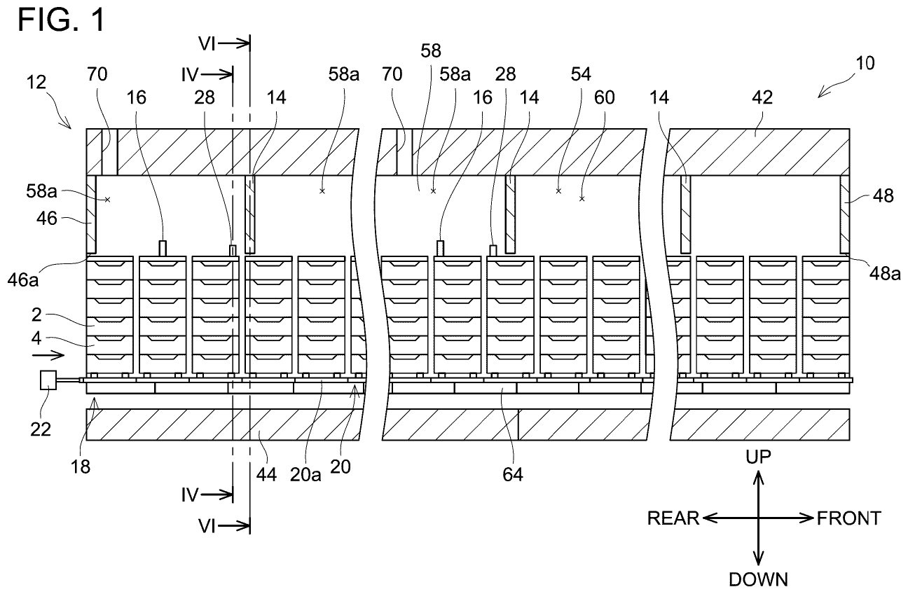

A heat treatment furnace 10 according to a first embodiment, shown in FIG. 1, heat-treats objects 2. Hereinafter, the longitudinal direction of the heat treatment furnace 10 is termed a front-rear direction, a direction perpendicular to the front-rear direction is termed a left-right direction, and the direction perpendicular to the front-rear direction and the left-right direction is termed an up-down direction. Further, forward means a direction from an entrance 46a toward an exit 48a, and rearward means a direction from the exit 48a toward the entrance 46a. Moreover, what is described about one of a plurality of elements in the following description is applied to the rest of the plurality of elements, unless otherwise stated.

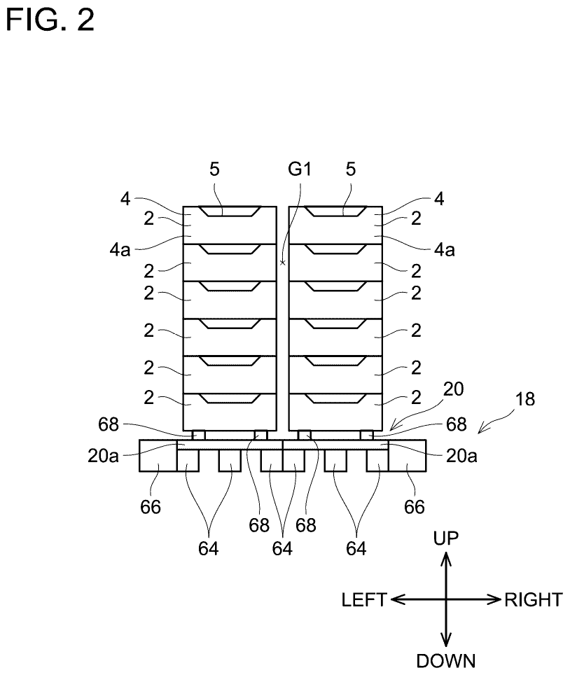

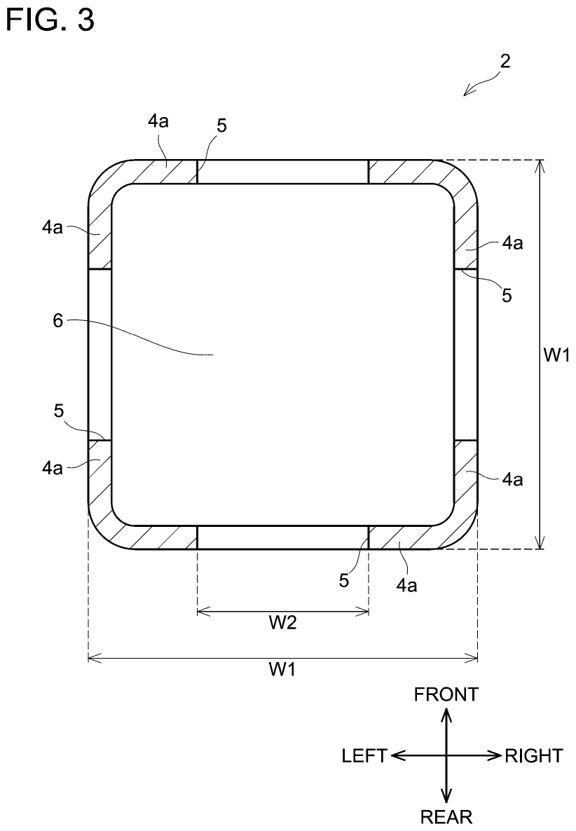

As shown in FIG. 2, each object 2 comprises a saggar 4 and a material 6 (see FIG. 3). The saggars 4 each have a substantially cuboid box shape. The saggars 4 each include a plurality of cutouts 5 (four cutouts 5 in this embodiment). The cutouts 5 are positioned in an upper portion of each saggar 4. As shown in FIG. 3, the four cutouts 5 are positioned in four side walls 4a of the saggar 4, respectively. The four side walls 4a have the same width W1. Two of the four cutouts 5 oppose each other in the front-rear direction, and the other two cutouts 5 oppose each other in the left-right direction. The cutouts 5 are configured to allow the inside of the saggar 4 to communicate with the outside thereof. A width W2 of the cutouts 5 is equal to or more than 30% and equal to or less than 70% of the width W1 of the side walls 4a. In this embodiment, the width W2 is 40% of the width W1. The width W2 may be equal to or more than 30% and equal to or less than 60% of the width W1.

The material 6 is inside the saggars 4. The material 6 is for example a raw material for a ceramic capacitor, a positive-electrode material, or a negative-electrode material of a lithium ion battery.

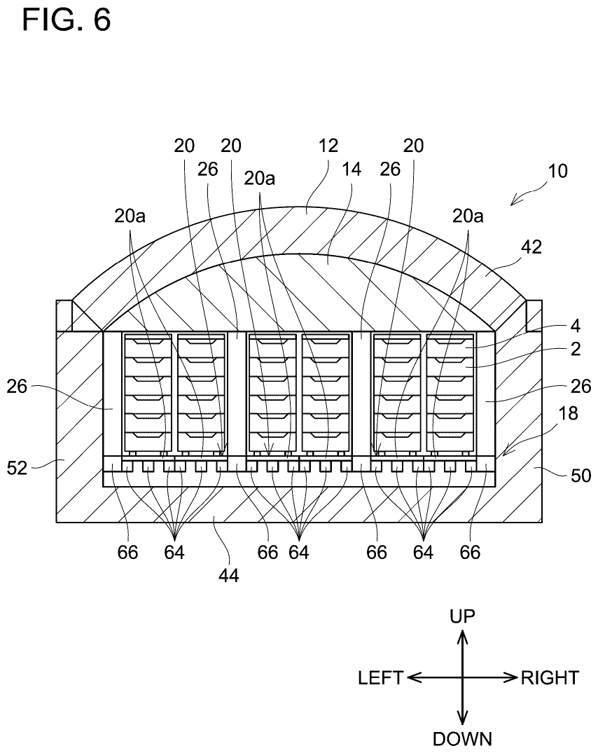

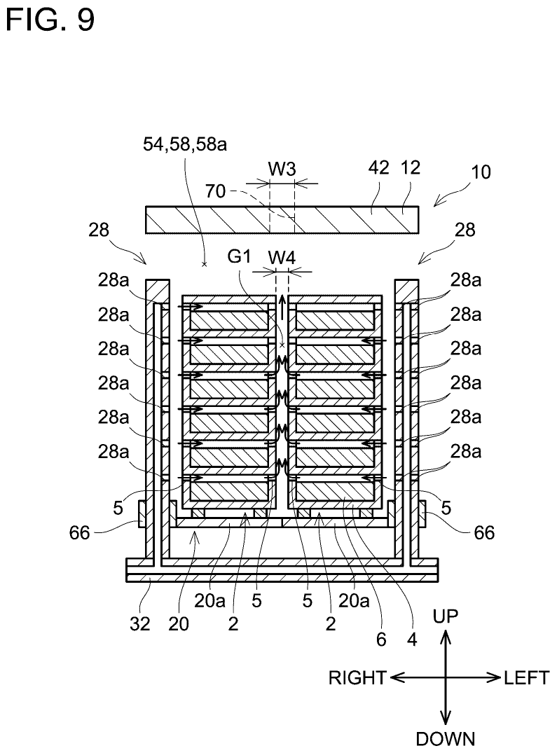

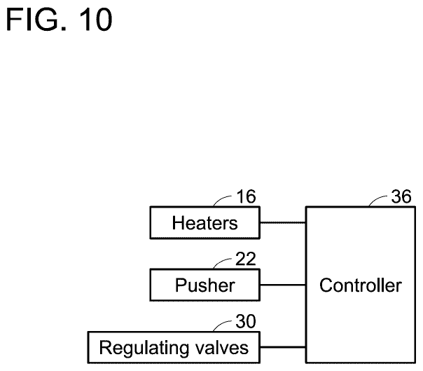

As shown in FIG. 1, the heat treatment furnace 10 comprises a furnace body 12, a plurality of first partition walls 14, a plurality of heaters 16, a guide member 18 (see FIG. 2), a plurality of movable members 20, a pusher 22, a plurality of second partition walls 26 (see FIG. 6), a plurality of gas supplying pipes 28, a plurality of regulating valves 30 (see FIG. 10), a plurality of supplying pipes 32 (see FIG. 9), and a controller 36 (see FIG. 10).

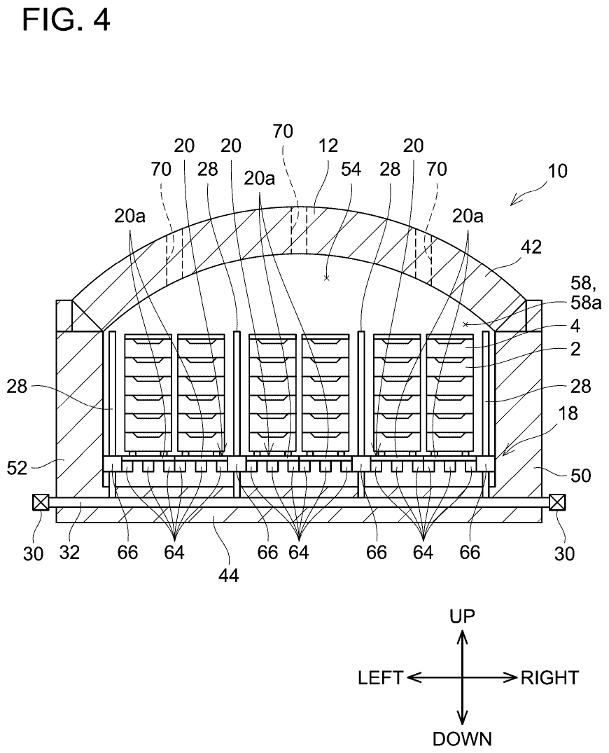

The furnace body 12 is a thermally insulating structure that has a substantially cuboid shape elongated in the front-rear direction. The furnace body 12 comprises an upper wall 42, a lower wall 44, a furnace entrance wall 46, a furnace exit wall 48, a right wall 50 (see FIG. 4), and a left wall 52 (see FIG. 4). The upper wall 42, the lower wall 44, the furnace entrance wall 46, the furnace exit wall 48, the right wall 50, and the left wall 52 define an internal space 54 within the furnace body 12. The upper wall 42 and the lower wall 44 extend in the front-rear direction. The upper wall 42 is positioned above the lower wall 44. The furnace entrance wall 46 is connected to rear ends of the upper wall 42 and the lower wall 44. The furnace entrance wall 46 includes an entrance 46a extending through the furnace entrance wall 46 in the front-rear direction. The internal space 54 communicates with the outside of the furnace body 12 through the entrance 46a. For example, the internal space 54 communicates with a displacement chamber (not shown) located outside the furnace body 12 through the entrance 46a. The furnace exit wall 48 is connected to front ends of the upper wall 42 and the lower wall 44. The furnace exit wall 48 includes an exit 48a extending through the furnace exit wall 48 in the front-rear direction. The internal space 54 communicates with the outside of the furnace body 12 through the exit 48a. For example, the internal space 54 communicates with a displacement chamber (not shown) located outside the furnace body 12 through the exit 48a. The exit 48a opposes the entrance 46a in the front-rear direction. As shown in FIG. 4, the right wall 50 and the left wall 52 are spaced apart from each other in the left-right direction. The right wall 50 opposes the left wall 52 in the left-right direction. The right wall 50 and the left wall 52 are connected to the upper wall 42, the lower wall 44, the furnace entrance wall 46 (see FIG. 1), and the furnace exit wall 48 (see FIG. 1).

As shown in FIG. 1, the first partition walls 14 are aligned in the front-rear direction. The first partition walls 14 extend downward from the upper wall 42. The first partition walls 14 partition the internal space 54 into a plurality of subspaces.

The internal space 54 comprises a heat treatment space 58 and a cooling space 60. The heat treatment space 58 is defined by the upper wall 42, the lower wall 44, the furnace entrance wall 46, the right wall 50 (see FIG. 4), the left wall 52 (see FIG. 4), and a first partition wall 14 that borders the cooling space 60. The heat treatment space 58 is in a rear portion of the furnace body 12. The heat treatment space 58 is partitioned by one or more first partition walls 14 into a plurality of furnace internal spaces 58a. The furnace internal spaces 58a are aligned in the front-rear direction. Each furnace internal space 58a communicates with its adjacent furnace internal space(s) 58a in the front-rear direction. A heater 16 is positioned in each of the furnace internal spaces 58a. The furnace internal spaces 58a (the heat treatment space 58) are heated by the heaters 16 generating heat.

The cooling space 60 is in a front portion of the furnace body 12. The cooling space 60 is defined by the upper wall 42, the lower wall 44, the furnace exit wall 48, the right wall 50 (see FIG. 4), the left wall 52 (see FIG. 4), and the first partition wall 14 that borders the heat treatment space 58. The cooling space 60 communicates with the heat treatment space 58. One or more cooling pipes (not shown) are positioned in the cooling space 60. The cooling space 60 is cooled by water or air flowing through the one or more cooling pipes.

The guide member 18 is positioned in the heat treatment space 58 and the cooling space 60. As shown in FIG. 2, the guide member 18 comprises a plurality of placement rails 64 and a plurality of guide rails 66 (see FIG. 4).

The placement rails 64 extend in the front-rear direction. As shown in FIG. 4, the placement rails 64 are aligned in the left-right direction.

The guide rails 66 extend in the front-rear direction. The guide rails 66 (four guide rails 66 in this embodiment) are spaced apart from each other in the left-right direction. Six placement rails 64 are arranged between each pair of guide rails 66 adjacent in the left-right direction. Upper surfaces of the guide rails 66 are positioned slightly above upper surfaces of the placement rails 64.

The movable members 20 are aligned in the front-rear direction and in the left-right direction. As shown in FIG. 2, each movable member 20 comprises one or more movable plates 20a (two movable plates 20a in this embodiment). The two movable plates 20a are aligned in the left-right direction. The movable plates 20a have a flat plate shape. Each movable plate 20a is configured to allow multiple objects 2 to be placed on its upper surface. In this embodiment, six objects 2 are stacked in the up-down direction on the upper surface of each movable plate 20a via spacers 68. There is an interval G1 between the stack of objects 2 on one of the two movable plates 20a, which are aligned in the left-right direction, and the stack of objects 2 on the other movable plate 20a. The multiple stacks of objects 2 are aligned in the left-right direction on the movable member 20 with the interval G1 interposed therebetween. In a variant, multiple stacks of objects 2 may be aligned in the left-right direction on a single movable plate 20a. In this case, the interval G1 is interposed between each pair of the stacks of objects 2 aligned in the left-right direction.

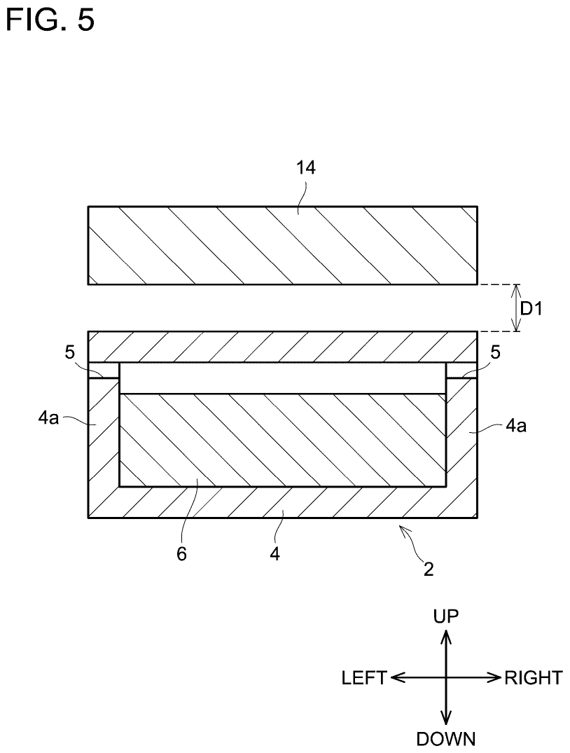

As shown in FIG. 5, the uppermost object 2 in a stack of objects 2 on a movable plate 20a is positioned below a first partition wall 14. The uppermost object 2 is spaced apart from the lower end of the first partition wall 14. In the up-down direction, a distance D1 between the uppermost object 2 and the lower end of the first partition wall 14 is equal to or more than 10 mm and equal to or less than 30 mm. Thus, the uppermost object 2 is suppressed from contacting the first partition wall 14. Further, the spacing between the uppermost object 2 and the first partition wall 14 is not excessively large. This suppresses a gas (e.g., furnace atmosphere gas to be described later) from flowing through the spacing between the uppermost object 2 and the first partition wall 14. The distance D1 may be equal to or more than 10 mm and equal to or less than 20 mm, or equal to or more than 10 mm and equal to or less than 15 mm.

As shown in FIG. 4, the movable members 20 are placed on the placement rails 64. Each movable member 20 is positioned between a corresponding pair of guide rails 66 adjacent in the left-right direction. Each of the guide rails 66 (excluding the rightmost and leftmost guide rails 66) is positioned between a corresponding pair of the movable members 20 aligned in the left-right direction. The movable members 20 (each comprising two movable plates 20a) are pushed by the pusher 22 (see FIG. 1) so that they are moved forward in the internal space 54 of the furnace body 12. The movable members 20 are guided forward by the guide rails 66 so as to slide on the placement rails 64. The objects 2 are heated while the movable members 20 are moving within the heat treatment space 58. The objects 2 are cooled while the movable members 20 are moving within the cooling space 60.

As shown in FIG. 1, the pusher 22 is located outside the furnace body 12 near the entrance 46a. The pusher 22 is configured to push the movable plates 20a forward. When the pusher 22 pushes the movable members 20 once, the movable members 20 are thereby moved by a distance corresponding to the length of the movable members 20 in the front-rear direction. In this embodiment, the pusher 22 simultaneously pushes forward three movable members 20 (six movable plates 20a) aligned in the left-right direction. Thereby, these three movable members 20 are pushed into the internal space 54 through the entrance 46a, and other movable members 20 already in the internal space 54 are pushed forward by the three movable members 20 being pushed. By the pusher 22 repeating to push the movable members 20, the movable members 20 are pushed into the internal space 54 through the entrance 46a, pass through the heat treatment space 58 and the cooling space 60 in this order, and are then pushed out from the furnace body 12 through the exit 48a. Detailed description for the pusher 22 is omitted herein because such pushers are well known.

As shown in FIG. 6, the second partition walls 26 extend upward from the upper surfaces of the guide rails 66 to a first partition wall 14. Upper ends of the second partition walls 26 are connected to the lower end of the first partition wall 14. The width of the second partition walls 26 in the left-right direction is substantially the same as the width of the guide rails 66 in the left-right direction. In this embodiment, four second partition walls 26 are aligned in the left-right direction. The rightmost second partition wall 26 is positioned rightward of the stacks of objects 2 on the rightmost movable member 20. The leftmost second partition wall 26 is positioned leftward of the stacks of objects 2 on the leftmost movable member 20. Each of the two middle second partition walls 26 is positioned between a stack of objects 2 on the movable member 20 on the right side of the middle second partition wall 26 and a stack of objects 2 on the movable member 20 on the left side of the middle second partition wall 26.

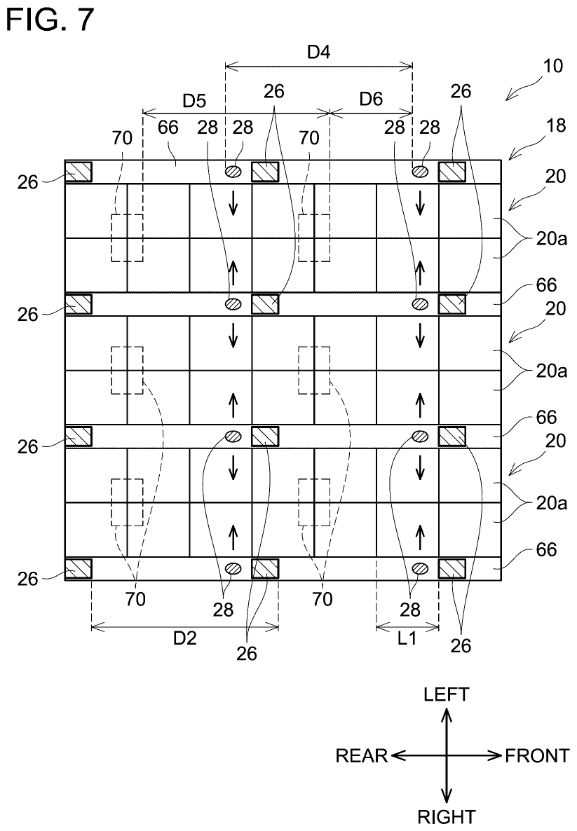

As shown in FIG. 7, the second partition walls 26 are also aligned in the front-rear direction. A distance D2 between each pair of second partition walls 26 adjacent in the front-rear direction is equal to or more than a length L1 of each movable member 20 (each movable plate 20a) in the front-rear direction. The distance D2 is an integral multiple of the length L1. The distance D2 is for example equal to or more than twice the length L1 and at most five times the length L1. In this embodiment, the distance D2 is three times the length L1.

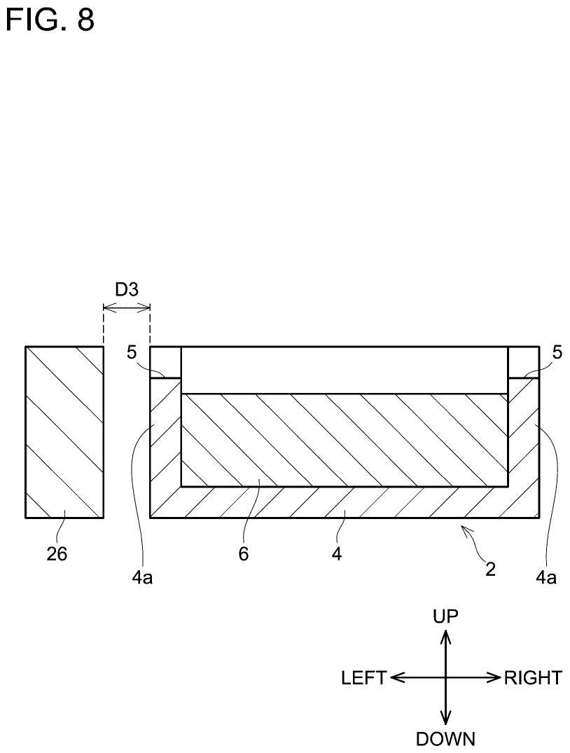

As shown in FIG. 8, a side surface of a second partition wall 26 is spaced in the left-right direction from a stack of objects 2 on a movable member 20. In the left-right direction, a distance D3 between the side surface of the second partition wall 26 and the stack of objects 2 is equal to or more than 10 mm and equal to or less than 30 mm. This suppresses the objects 2 from contacting the second partition wall 26. Further, the spacing between the stack of objects 2 and the second partition wall 26 is not excessively large. This suppresses a gas (e.g., furnace atmosphere gas to be described later) from flowing through the spacing between the stack of objects 2 on the movable plate 20a and the second partition wall 26. The distance D3 may be equal to or more than 10 mm and equal to or less than 20 mm, or equal to or more than 10 mm and equal to or less than 15 mm.

As shown in FIG. 4, the gas supplying pipes 28 are positioned in the heat treatment space 58. The gas supplying pipes 28 are constituted of ceramics, such as mullite, alumina, silicon carbide, etc. Multiple gas supplying pipes 28 (four gas supplying pipes 28 in this embodiment) are aligned in the left-right direction. The gas supplying pipes 28 are inserted in the guide rails 66. The rightmost gas supplying pipe 28 is positioned rightward of the stacks of objects 2 on the rightmost movable member 20. The leftmost gas supplying pipe 28 is positioned leftward of the stacks of objects 2 on the leftmost movable member 20. Each of the two middle gas supplying pipes 28 is positioned between a stack of objects 2 on the movable member 20 on the right side of the guide rail 66 and a stack of objects 2 on the movable member 20 on the left side of the guide rail 66.

As shown in FIG. 7, the gas supplying pipes 28 are also aligned in the front-rear direction. A distance D4 between each pair of gas supplying pipes 28 adjacent in the front-rear direction is equal to or more than the length L1. The distance D4 is an integral multiple of the length L1. The distance D4 is for example equal to or more than twice the length L1 and at most five times the length L1. In this embodiment, the distance D4 is three times the length L1. Further, the distance D4 is substantially the same as the distance D2.

As shown in FIG. 9, the gas supplying pipes 28 extend upward from the guide rails 66 toward the upper wall 42. Upper ends of the gas supplying pipes 28 are positioned above upper ends of the uppermost objects 2 in the stacks of objects 2 on the movable plates 20a. The gas supplying pipes 28 are spaced apart in the left-right direction from the stacks of objects 2 on the movable plates 20a.

The gas supplying pipes 28 are configured to supply furnace atmosphere gas to the heat treatment space 58. The furnace atmosphere gas is for example air, oxygen gas, or nitrogen gas. Each gas supplying pipe 28 includes a plurality of gas supplying openings 28a. In this embodiment, six gas supplying openings 28a are aligned in the up-down direction. The distance between each pair of gas supplying openings 28a adjacent in the up-down direction is substantially the same as the width of the saggars 4 in the up-down direction. In the rightmost gas supplying pipe 28, six gas supplying openings 28a are positioned along its left end. In the leftmost gas supplying pipe 28, six gas supplying openings 28a are positioned along its right end. In each of the two middle gas supplying pipes 28, six gas supplying openings 28a are positioned along each of its right and left ends. With regard to each pair of gas supplying pipes 28 adjacent in the left-right direction, the gas supplying openings 28a of one of the gas supplying pipes 28 face the gas supplying openings 28a of the other gas supplying pipe 28 in the left-right direction.

As shown in FIG. 9, the gas supplying openings 28a face the cutouts 5 of the saggars 4 in the left-right direction. That is, in the up-down direction, the positions of the gas supplying openings 28a are substantially the same as the positions of the cutouts 5. The furnace atmosphere gas is supplied from the gas supplying openings 28a rightward and/or leftward as it flows toward the cutouts 5. Thus, the furnace atmosphere gas flows into the saggars 4 through the cutouts 5 and then flows out of the saggars 4 through the cutouts 5, i.e., flows into the interval G1. By the furnace atmosphere gas flowing through the saggars 4, a gas generated from the material 6 (which may be termed “secondary gas” hereinafter) is pushed out from the saggars 4. The same amount of furnace atmosphere gas is supplied through each gas supplying opening 28a. Therefore, the furnace atmosphere gas is evenly supplied to the objects 2 stacked on the movable plates 20a.

As shown in FIG. 4, the regulating valves 30 are located outside the furnace body 12. The regulating valves 30 are configured to open and close. The regulating valves 30 adjust an amount of the furnace atmosphere gas to be supplied from the gas supplying openings 28a into the heat treatment space 58. The regulating valves 30 permit the furnace atmosphere gas to be supplied from the gas supplying openings 28a into the heat treatment space 58 when the regulating valves 30 are open. The regulating valves 30 prohibit the furnace atmosphere gas from being supplied from the gas supplying openings 28a into the heat treatment space 58 when the regulating valves 30 are closed.

Each supplying pipe 32 is connected to four gas supplying pipes 28 aligned in the left-right direction. The supplying pipes 32 extend linearly. In a variant, the supplying pipes 32 may extend in a zig-zag manner. The supplying pipes 32 supply the furnace atmosphere gas to the gas supplying pipes 28. The supplying pipes 32 extend through the lower wall 44, thus penetrate the lower wall 44. In each supplying pipe 32, the furnace atmosphere gas flows from right and left ends of the supplying pipe 32 toward the center thereof. While flowing through the supplying pipes 32, the furnace atmosphere gas is heated by the lower wall 44. Thus, the heated furnace atmosphere gas is supplied to the gas supplying pipes 28. This suppresses a temperature drop in the heat treatment space 58 when the furnace atmosphere gas is supplied from the gas supplying openings 28a of the gas supplying pipes 28 into the heat treatment space 58.

As shown in FIG. 1, the furnace body 12 includes a plurality of gas exhausting openings 70. The gas exhausting openings 70 are defined in the upper wall 42. The gas exhausting openings 70 extend through the upper wall 42 in the up-down direction. The gas exhausting openings 70 allow the internal space 54 of the furnace body 12 to communicate with the outside of the furnace body 12.

At least one gas exhausting opening 70 is positioned in each of the furnace internal spaces 58a. The gas exhausting openings 70 are aligned in the front-rear direction. In the front-rear direction, each gas exhausting opening 70 is positioned near corresponding one of the first partition walls 14. Each gas exhausting opening 70 is positioned rearward of corresponding gas supplying pipes 28. As shown in FIG. 7, a distance D5 between each pair of gas exhausting openings 70 adjacent in the front-rear direction is equal to or more than the length L1. The distance D5 is an integral multiple of the length L1. The distance D5 is for example equal to or more than twice the length L1 and at most five times the length L1. In this embodiment, the distance D5 is three times the length L1. The distance D5 is substantially the same as the distance D2. With regard to gas exhausting openings 70 and gas supplying pipes 28 in the same furnace internal space 58a, a distance D6 in the front-rear direction between each gas exhausting opening 70 and its corresponding gas supplying pipes 28 is more than the length L1.

The gas exhausting openings 70 are also aligned in the left-right direction (three gas exhausting openings 70 are aligned in the left-right direction in this embodiment). Each gas exhausting opening 70 is positioned immediately above the center position between a corresponding pair of guide rails 66 adjacent in the left-right direction. Each gas exhausting opening 70 is positioned immediately above the border between two movable plates 20a, which are aligned in the left-right direction, of a corresponding one of the movable members 20.

As shown in FIG. 9, as the heat treatment furnace 10 is viewed in the front-rear direction, a gas exhausting opening 70 is positioned immediately above the interval G1 between two stacks of objects 2 aligned in the left-right direction on a movable member 20. As the heat treatment furnace 10 is viewed in the front-rear direction, the gas exhausting opening 70 overlaps the interval G1 in the up-down direction. The center position of the interval G1 in the left-right direction substantially coincides with the center position of the gas exhausting opening 70 in the left-right direction. A width W3 of the gas exhausting opening 70 in the left-right direction is equal to or more than a width W4 of the interval G1 in the left-right direction. The width W3 is at least the same as the width W4 and at most three times the width W4. This suppresses the furnace atmosphere gas and the secondary gas, which have flown through the interval G1, from stagnating between the upper wall 42 and the stacks of objects 2. The width W3 may be at least the same as the width W4 and at most 2.5 times the width W4, or at least the same as the width W4 and at most twice the width W4.

As shown in FIG. 10, the controller 36 is electrically connected to the heaters 16, the pusher 22, and the regulating valves 30. The controller 36 controls the heaters 16 to cause them to generate heat. The controller 36 controls the pusher 22 to cause it to push the movable members 20.

Further, the controller 36 stores in advance the length L1 of the movable members 20 (movable plates 20a) in the front-rear direction; the width W2 of the cutouts 5 of the saggars 4; a cutout position, which is the position of cutouts 5 in the front-rear direction within a movable member 20; a moving speed at which the movable members 20 are moved forward by the pushing of the pusher 22; and positions of the gas supplying pipes 28. Based on the length L1, the width W2, the cutout position, the moving speed, and the positions of the gas supplying pipes 28, the controller 36 calculates and stores timings at which the gas supplying pipes 28 overlap the cutouts 5 in the left-right direction while the movable members 20 are being moved by the pushing of the pusher 22. Between a time 1 after the start of pushing by the pusher 22 and a time 2, the gas supplying pipes 28 overlap the cutouts 5 in the left-right direction. When the pusher 22 starts pushing the movable members 20, the controller 36 controls opening and closing of the regulating valves 30 based on the timings at which the gas supplying pipes 28 overlap the cutouts 5 in the left-right direction.

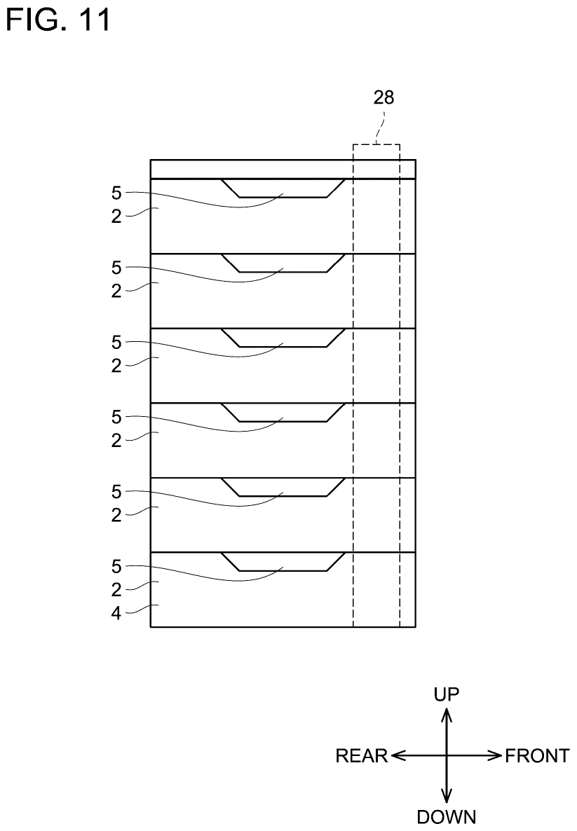

Specifically, the controller 36 maintains the regulating valves 30 closed until after the time 1 from the start of pushing by the pusher 22 to the movable members 20. At this time, each gas supplying pipe 28 does not overlap the cutouts 5 in the left-right direction, as shown in FIG. 11.

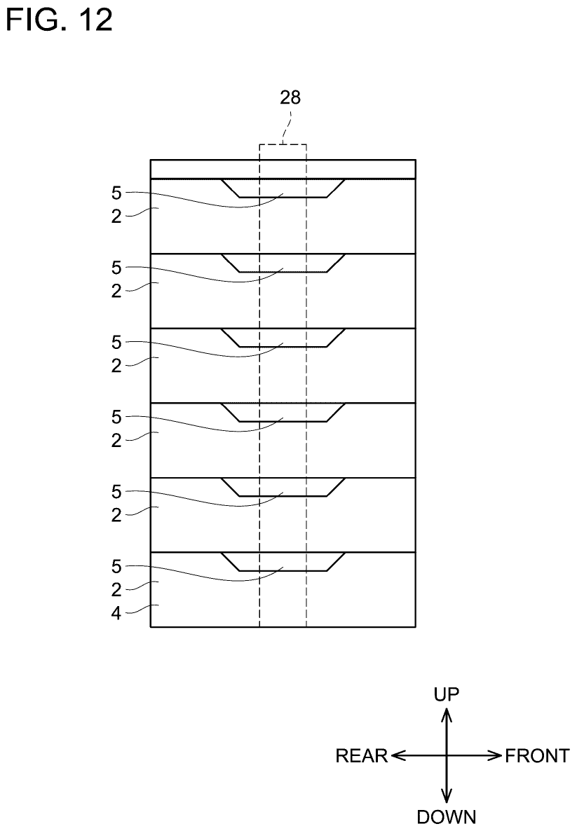

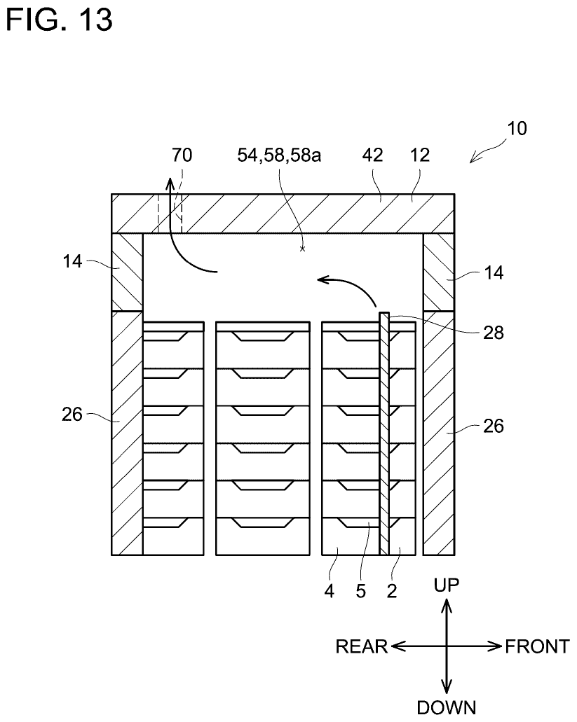

The controller 36 opens the regulating valves 30 after the time 1 from the start of pushing by the pusher 22 to the movable members 20. At this time, each gas supplying pipe 28 overlaps the cutouts 5 in the left-right direction, as shown in FIG. 12. Since the regulating valves 30 are opened, the furnace atmosphere gas is supplied from the gas supplying openings 28a of the gas supplying pipes 28 rightward and/or leftward as it flows toward the cutouts 5. Since the gas supplying pipes 28 are positioned rearward of their corresponding second partition walls 26 as shown in FIG. 7, the furnace atmosphere gas is suppressed from flowing from a furnace internal space 58a into another furnace internal space 58a beyond the second partition walls 26. As shown in FIG. 9, the furnace atmosphere gas flows into the saggars 4 through the cutouts 5, and then flows out to the interval G1 through the cutouts 5 together with the secondary gas. The furnace atmosphere gas in the interval G1 flows, together with the secondary gas, upward along the side surfaces of the objects 2 (in the stacking direction of the objects 2). When reaching beyond the upper ends of the uppermost objects 2, the furnace atmosphere gas flows, together with the secondary gas, in the furnace internal space 58a along the upper wall 42 rearward, which is opposite to the moving direction of the movable members 20 (forward), as shown in FIG. 13. FIG. 13 shows a cross-sectional view of a second partition wall 26 and a gas supplying pipe 28. Since the distance D1 (see FIG. 5) between the uppermost objects 2 and the first partition walls 14 is equal to or more than 10 mm and equal to or less than 30 mm, the furnace atmosphere gas and the secondary gas are suppressed from flowing forward beyond the first partition walls 14 from a furnace internal space 58a into another furnace internal space 58a. The furnace atmosphere gas then flows through the gas exhausting openings 70 together with the secondary gas, so that it is exhausted from the furnace internal spaces 58a to the outside of the furnace body 12. As shown in FIG. 9, since each gas exhausting opening 70 is positioned immediately above the interval G1 between two stacks of objects 2 aligned in the left-right direction on corresponding one of the movable members 20 as the heat treatment furnace 10 is viewed in the front-rear direction, the furnace atmosphere gas smoothly flows into the gas exhausting openings 70 together with the secondary gas. Therefore, the furnace atmosphere gas and the secondary gas are suppressed from stagnating within the furnace internal spaces 58a.

The controller 36 closes the regulating valves 30 after the time 2 from the start of pushing by the pusher 22 to the movable members 20. Thereby the supply of furnace atmosphere gas from the gas supplying openings 28a stops. At this time, the gas supplying pipes 28 do not overlap the cutouts 5 in the left-right direction. Since the regulating valves 30 are opened only between the time 1 and the time 2, the amount of furnace atmosphere gas supplied can be reduced and the furnace atmosphere gas can be more efficiently supplied into the saggars 4 as compared to a configuration in which the regulating valves 30 are constantly opened.

### (Effects)

In the first embodiment described above, as the heat treatment furnace 10 is viewed in the front-rear direction, each gas exhausting opening 70 is positioned immediately above the interval G1 between two stacks of objects 2 aligned in the left-right direction on corresponding one of the movable members 20. In this configuration, the furnace atmosphere gas, together with the secondary gas, first flows through the interval G1 between the two stacks of objects 2 aligned in the left-right direction, thereafter flows upward toward the gas exhausting opening 70, and then is exhausted through the gas exhausting opening 70 to the outside of the furnace body 12. Thus, the furnace atmosphere gas and the secondary gas are suppressed from stagnating within the furnace body 12.

### SECOND EMBODIMENT

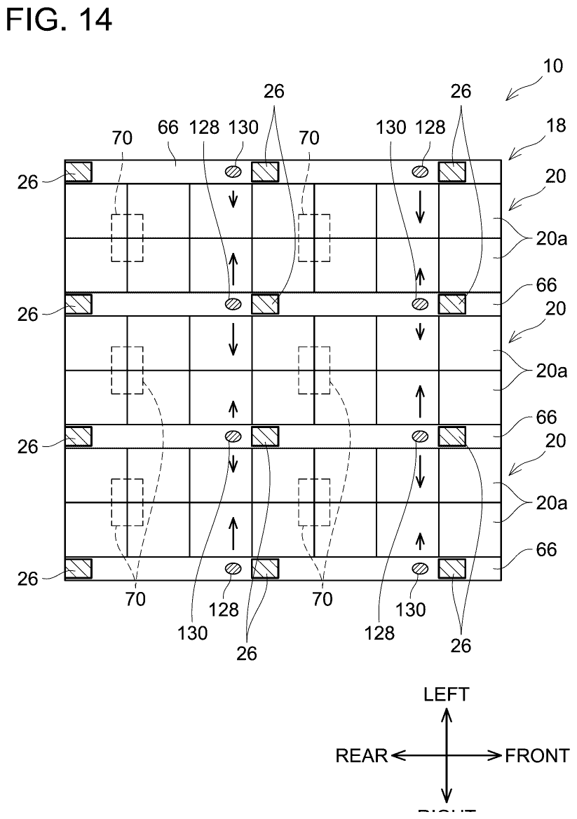

For a second embodiment, only the differences from the first embodiment are described. As shown in FIG. 14, the gas supplying pipes 28 comprise a plurality of first gas supplying pipes 128 and a plurality of second gas supplying pipes 130. The first gas supplying pipes 128 and the second gas supplying pipes 130 have the same configuration as that of the gas supplying pipes 28 in the first embodiment. The first gas supplying pipes 128 and the second gas supplying pipes 130 are arranged alternately in the front-rear direction. The first gas supplying pipes 128 and the second gas supplying pipes 130 are also arranged alternately in the left-right direction. With regard to each pair of a first gas supplying pipe 128 and a second gas supplying pipe 130 adjacent in the left-right direction, the gas supplying openings 28a (see FIG. 9) of the first gas supplying pipe 128 face the gas supplying openings 28a of the second gas supplying pipe 130 in the left-right direction.

The regulating valves 30 (see FIG. 10) switch between a first open position and a second open position. When the regulating valves 30 are in the first open position, the furnace atmosphere gas is supplied in a first supplying amount from the gas supplying openings 28a (see FIG. 9) of the gas supplying pipes 28. When the regulating valves 30 are in the second open position, the furnace atmosphere gas is supplied in a second supplying amount from the gas supplying openings 28a. The second supplying amount is different from the first supplying amount. The second supplying amount is less than the first supplying amount.

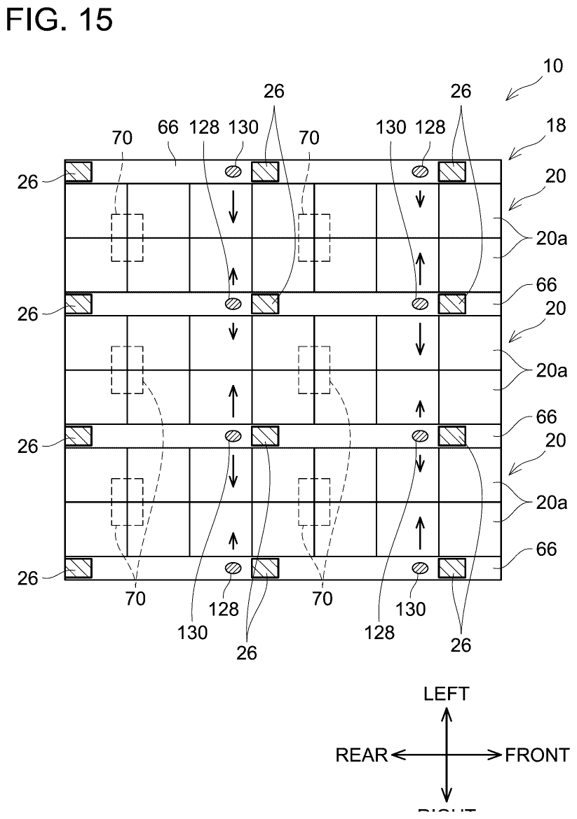

The controller 36 switches the regulating valves 30 between the first open position and the second open position. The controller 36 controls the regulating valves 30 such that the open position of regulating valves 30 connected to the first gas supplying pipes 128 differ from the open position of regulating valves 30 connected to the second gas supplying pipes 130. Specifically, the controller 36 (see FIG. 10) switches the regulating valves 30 (see FIG. 10) connected to the second gas supplying pipes 130 from the first open position to the second open position when switching the regulating valves 30 (see FIG. 10) connected to the first gas supplying pipes 128 from the second open position to the first open position. Thereby, as shown in FIG. 14, the furnace atmosphere gas is supplied in the first supplying amount from the gas supplying openings 28a (see FIG. 9) of the first gas supplying pipes 128 into the heat treatment furnace 58 and supplied in the second supplying amount from the gas supplying openings 28a (see FIG. 9) of the second gas supplying pipes 130 into the heat treatment space 58. In FIGS. 14 and 15, the furnace atmosphere gas flow is indicated by arrows.

The controller 36 switches the regulating valves 30 connected to the second gas supplying pipes 130 from the second open position to the first open position when switching the regulating valves 30 connected to the first gas supplying pipes 128 from the first open position to the second open position. Thereby, as shown in FIG. 15, the furnace atmosphere gas is supplied in the second supplying amount from the gas supplying openings 28a of the first gas supplying pipes 128 into the heat treatment furnace 58 and supplied in the first supplying amount from the gas supplying openings 28a of the second gas supplying pipes 130 into the heat treatment space 58. By controlling the regulating valves 30 such that the open position of the regulating valves 30 connected to the first gas supplying pipes 128 differs from the open position of the regulating valves 30 connected to the second gas supplying pipes 130, the furnace atmosphere gas is stirred in the heat treatment space 58. The concentrations of components of the secondary gas are thereby evened out in the furnace atmosphere gas within the heat treatment space 58.

### (Correspondence Relationships)

A first gas supplying pipe 128 corresponds to “one of the gas supplying pipes”, and a second gas supplying pipe 130 corresponds to “the other of the gas supplying pipes”.

### THIRD EMBODIMENT

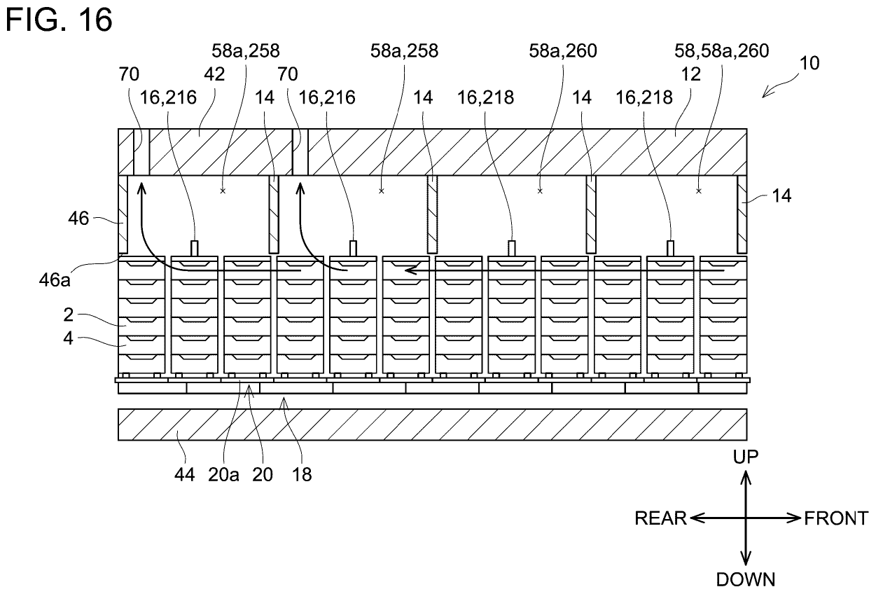

For a third embodiment, only differences from the first embodiment are described. As shown in FIG. 16, the heaters 16 comprises a plurality of heating heaters 216 and a plurality of heat-retention heaters 218. In FIG. 16, the heat treatment space 58 is shown but the cooling space 60 is not shown. The plurality of heating heaters 216 is positioned in a part of the heat treatment space 58 near the entrance 46a. Hereinafter, this part of the heat treatment space 58 near the entrance 46a is termed a heating space 258. The heating space 258 communicates with the entrance 46a. The heating space 258 comprises a plurality of furnace internal spaces 58a.

The plurality of heat-retention heaters 218 is positioned forward of the plurality of heating heaters 216. The heat-retention heaters 218 are positioned in a part of the heat treatment space 58 closer to the exit 48a (see FIG. 1). Hereinafter, this part of the heat treatment space 58 closer to the exit 48a is termed a heat-retention space 260. The heat-retention space 260 communicates with the heating space 258. The heat-retention space 260 is positioned forward of the heating space 258. The heat-retention space 260 comprises a plurality of furnace internal spaces 58a.

The heating heaters 216 generate a larger amount of heat than the heat-retention heaters 218. The heating heaters 216 increase the temperature in the heating space 258. The heat-retention heaters 218 maintain the temperature substantially constant in the heat-retention space 260. The temperature in the heat-retention space 260 is higher than the temperature in the heating space 258.

The gas exhausting openings 70 are positioned in the heating space 258. At least one gas exhausting opening 70 is positioned in each of the furnace internal spaces 58a. In each furnace internal space 58a, the at least one gas exhausting opening 70 is positioned rearward of the heating heater(s) 216.

In the third embodiment, the furnace atmosphere gas supplied through the gas supplying openings 28a (see FIG. 9) of the gas supplying pipes 28 into the heat-retention space 260 flows in the direction toward the entrance 46a (rearward) in the heat-retention space 260. In FIG. 16, the furnace atmosphere gas flow is indicated by arrows. The furnace atmosphere gas then flows from the heat-retention space 260 into the heating space 258, together with the secondary gas. The heating space 258 is heated by the furnace atmosphere gas heated in the heat-retention space and flowing into the heating space 258. This allows for a reduction in an amount of heat generation by the heating heaters 216 as compared to a configuration in which the furnace atmosphere gas does not flow from the heat-retention space 260 into the heating space 258. Once having flowed into the heating space 258, the furnace atmosphere gas flows toward the gas exhausting openings 70 together with the secondary gas and is then exhausted through the gas exhausting openings 70 to the outside of the furnace body 12. Thus, the furnace atmosphere gas and the secondary gas are suppressed from stagnating within the heating space 258 and the heat-retention space 260.

### FOURTH EMBODIMENT

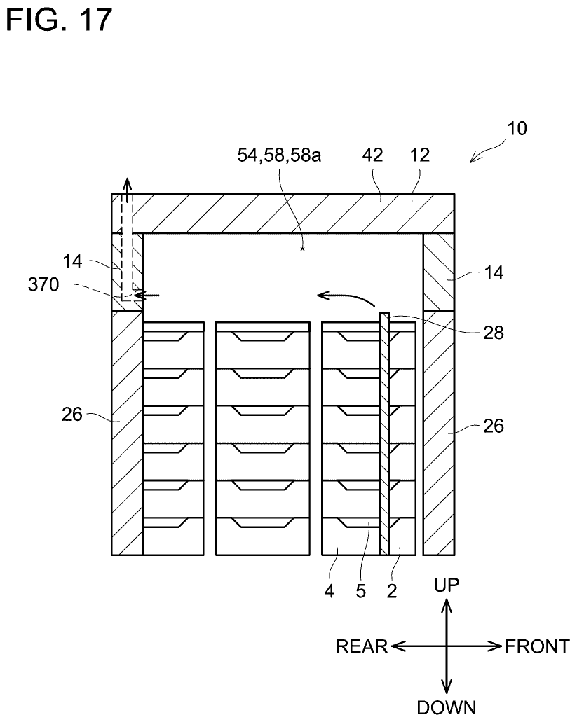

For a fourth embodiment, only differences from the first embodiment are described. As shown in FIG. 17, each gas exhausting opening 370 is defined in corresponding one of the first partition walls 14 and the upper wall 42 of the furnace body 12. Each gas exhausting opening 370 is positioned above the uppermost objects 2. Each gas exhausting opening 370 extends rearward from the front surface of the corresponding one of the first partition walls 14, bends upward, and extends upward through the first partition wall 14 and the upper wall 42. The gas exhausting openings 370 are open forward in the furnace internal spaces 58a. The gas exhausting openings 370 allow the furnace internal spaces 58a to communicate with the outside of the furnace body 12.

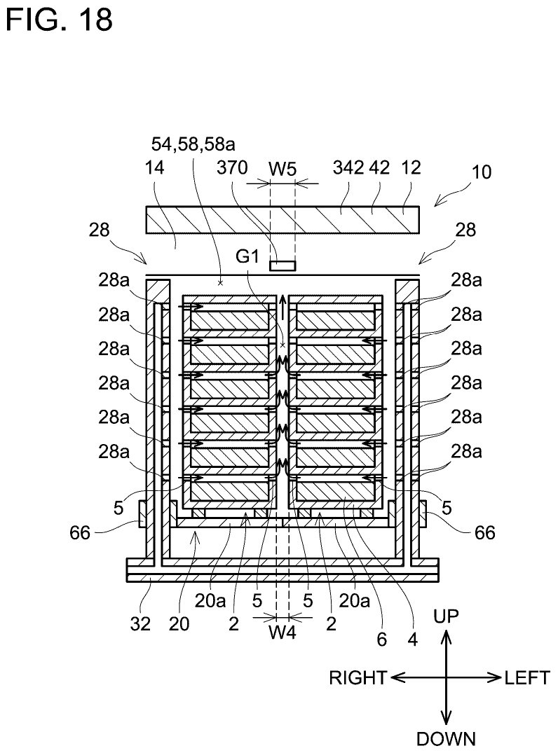

As shown in FIG. 18, as the heat treatment furnace 10 is viewed in the front-rear direction, a gas exhausting opening 370 is positioned immediately above an interval G1. The center position of the interval G1 in the left-right direction substantially coincides with the center position of the gas exhausting opening 370 in the left-right direction. A width W5 of the gas exhausting opening 370 in the left-right direction is substantially the same as the width W3 of the gas exhausting opening 70 in the left-right direction in the first embodiment. The width W5 is equal to or more than the width W4 of the interval G1 in the left-right direction.

The furnace atmosphere gas flows upward in the interval G1 together with the secondary gas. As shown in FIG. 17, once reaching beyond the upper ends of the uppermost objects 2, the furnace atmosphere gas flows, together with the secondary gas, rearward which is opposite to the moving direction of the movable members 20 (forward) within the furnace internal space 58a. The furnace atmosphere gas flows through the gas exhausting opening 370 together with the secondary gas and is then exhausted from the furnace internal space 58a to the outside of the furnace body 12.

### (Variant)

In an embodiment, the controller 36 may maintain the regulating valves 30 open while the pusher 22 is pushing the movable members 20.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment furnace comprising:
a furnace body comprising an entrance, an exit, and a heat treatment space in which a plurality of objects is heat-treated;
a plurality of movable members on which stacks of objects stacked in an up-down direction are aligned at intervals in a left-right direction perpendicular to the up-down direction, the plurality of movable members being aligned in a front-rear direction;
a pusher configured to push the plurality of movable members forward from the entrance of the furnace body to the exit of the furnace body; and
a plurality of gas supplying pipes each comprising a gas supplying opening through which furnace atmosphere gas is supplied into the heat treatment space, the gas supplying pipes being aligned in the left-right direction,
wherein
each of the movable members is positioned between a corresponding pair of the gas supplying pipes adjacent in the left-right direction,
the gas supplying openings of the gas supplying pipes are arranged so as to supply the furnace atmosphere gas to the stacks of objects,
the heat treatment furnace includes a plurality of gas exhausting openings through which the furnace atmosphere gas in the heat treatment space is exhausted to outside of the furnace body, and
as the furnace body is viewed in the front-rear direction, the gas exhausting openings are positioned directly above the intervals between the stacks of objects aligned in the left-right direction on the movable members.

2. The heat treatment furnace according to claim 1, wherein a width of the gas exhausting openings in the left-right direction is at least the same as a width of the intervals in the left-right direction between the stacks of objects aligned in the left-right direction and at most three times the width of the intervals.

3. The heat treatment furnace according to claim 1, wherein
the gas supplying pipes are aligned in the front-rear direction, and
a distance between each pair of the gas supplying pipes adjacent in the front-rear direction is an integral multiple of a length of each movable member in the front-rear direction.

4. The heat treatment furnace according to claim 1, further comprising:
a regulating valve configured to permit the furnace atmosphere gas to be supplied from the gas supplying openings when the regulating valve is open and prohibit the furnace atmosphere gas from being supplied from the gas supplying openings when the regulating valve is closed; and
a controller configured to control opening and closing of the regulating valve,
wherein each of the objects comprises a cutout at an upper portion of the object and the cutout is configured to allow inside of the object to communicate with outside of the object, and
the controller is configured to open the regulating valve when the gas supplying pipes overlap the cutouts in the left-right direction.

5. The heat treatment furnace according to claim 1, further comprising:
a plurality of regulating valves, wherein the regulating valves are configured to switch a supplying amount of the furnace atmosphere gas to be supplied from the gas supplying openings between a first supplying amount and a second supplying amount different from the first supplying amount; and
a controller configured to control the plurality of regulating valves,
wherein with regard to each pair of the gas supplying pipes adjacent in the left-right direction, the gas supplying opening of one of the gas supplying pipes faces the gas supplying opening of the other of the gas supplying pipes, and
the controller is configured to switch the supplying amount to be supplied from the gas supplying opening of the other of the gas supplying pipes to the second supplying amount when switching the supplying amount to be supplied from the gas supplying opening of the one of the gas supplying pipes to the first supplying amount.

6. The heat treatment furnace according to claim 1, wherein
the heat treatment space comprises a plurality of furnace internal spaces aligned in the front-rear direction and defined by a plurality of first partition walls positioned above the objects, and
at least one gas exhausting opening is positioned in each of the plurality of furnace internal spaces.

7. The heat treatment furnace according to claim 6, further comprising:
a plurality of guide rails extending in the front-rear direction and configured to guide the movable members forward, wherein each of the movable members is positioned between a corresponding pair of the guide rails adjacent in the left-right direction; and
a plurality of second partition walls extending from the guide rails to the first partition walls.

8. The heat treatment furnace according to claim 7, wherein a distance between each second partition wall and the stacks of the objects in the left-right direction is equal to or more than 10 mm and equal to or less than 30 mm.

9. The heat treatment furnace according to claim 6, wherein in each of the furnace internal spaces, a distance between the at least one gas exhausting opening and the gas supplying pipes in the front-rear direction is more than a length of the movable members in the front-rear direction.

10. The heat treatment furnace according to claim 6, wherein a distance between the first partition walls and the stacks of the objects is equal to or more than 10 mm and equal to or less than 30 mm.

11. The heat treatment furnace according to claim 1, further comprising a heating heater and a heat-retention heater positioned in the heat treatment space,
wherein the heat treatment space comprises a plurality of furnace internal spaces aligned in the front-rear direction,
the plurality of furnace internal spaces comprises:
a heating space in which the heating heater is positioned and communicating with the entrance; and
a heat-retention space in which the heat-retention heater is positioned and communicating with the heating space, and
the gas exhausting openings are positioned in the heating space.

12. The heat treatment furnace according to claim 1, wherein the gas supplying pipes are constituted of ceramics.

13. The heat treatment furnace according to claim 1, further comprising supplying pipes connected to the gas supplying pipes and configured to supply the furnace atmosphere gas to the gas supplying pipes,
wherein the supplying pipes extend through a wall portion of the furnace body.
